(19) United States
(12) Patent Application Publication
(10) Pub. No.: US 2009/0146595 A1
(43) Pub. Date: Jun. 11, 2009

(54) Device for supplying a plurality of multiphase electric loads

(76) Inventor: Thomas Immler, Scheidegg (DE)

Correspondence Address: DILWORTH & BARRESE, LLP, 333 EARLE OVINGTON BLVD., SUITE 702, UNIONDALE, NY, 11553, US

(21) Appl. No.: 12/283,887

(22) Filed: Sep. 16, 2008

(30) Foreign Application Priority Data
Sep. 17, 2007 (DE) 10 2007 044 226.4

(51) Int. Cl. H02P 6/00

(52) U.S. Cl. 318/400.29

(57) ABSTRACT

The present invention relates to a device for supplying a plurality of multiphase electric loads, wherein the device includes at least one multilevel pulse-controlled inverter which comprises at least one decided and at least one multiple semiconductor switch.

The present invention relates to a device for supplying a plurality of multiphase electric loads.

It is known from the prior art to activate multiphase loads, such as three-phase a.c. motors, via inverters.

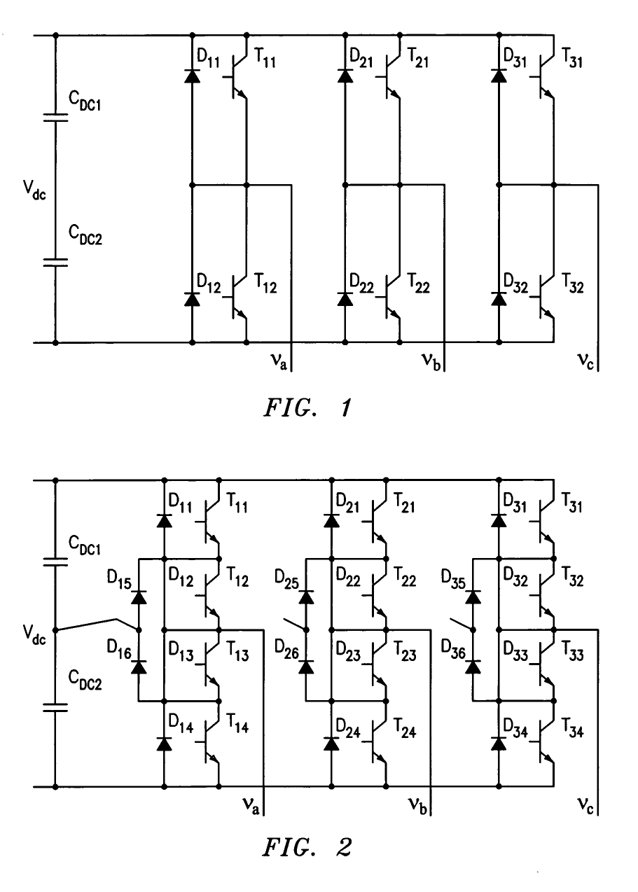

FIG. 1 shows a pulse-controlled inverter structure known from the prior art.

From the prior art, so-called multilevel pulse-controlled inverters are also known. A pulse-controlled inverter structure in the form of a multilevel pulse-controlled inverter allows to apply a plurality of voltage vectors to a machine. FIG. 2 shows a standard multilevel pulse-controlled inverter structure in the diode-clamped configuration.

The multilevel topology shown in FIG. 2 has certain advantages as compared to conventional inverter circuits. These advantages for instance consist in that a plurality of voltage vectors can be applied to the load, whereby a reduction of the current ripple and hence of the filtering effort can be achieved. Furthermore, the multilevel structure provides for a reduction of the power loss by a suitable choice of the semiconductor components and for a redundancy by means of a series connection of the semiconductor components. As compared to conventional inverter circuits known from the prior art, further advantages include a reduction of weight and costs. a reduction of the filtering effort, and a reduction of the current ripple in low-induction machines.

It is the object underlying the present invention to develop a device for supplying a plurality of multiphase electric loads to the effect that the amount of circuitry is reduced as compared to prior art inverters and/or that the fault tolerance and hence the reliability of the arrangement is increased.

This object is solved by a device with the features of claim 1. Accordingly, it is provided that the device includes at least one multilevel pulse-controlled inverter, which comprises at least one decided and at least one multiple semiconductor switch. By a decided semiconductor switch it is meant in accordance with the present invention that the switch or the switch configuration comprising the switch exclusively (decidedly) is used for activating a phase branch of one of the multiphase loads. By a multiple semiconductor switch, on the other hand, it is meant that the same is used for activating a plurality of phases, i.e. for instance for activating two phase branches of different multiphase loads.

The switch configuration can for instance be made in the form of a half-bridge.

The control of the multiphase electric loads can be effected by means of a common control unit or also control logic.

The pulse-controlled inverter preferably is configured such that two or more than two voltage levels can be applied to the loads.

In a preferred aspect of the invention it is provided that the multiple semiconductor switch(es) is/are arranged on a higher level of the pulse-controlled inverter than the decided semiconductor switch(es).

It is conceivable, for instance, that the at least one decided semiconductor switch is arranged on the innermost level of the multilevel pulse-controlled inverter. Thus, it is conceivable, for instance, that the lowermost voltage level (inner voltage level) is connected with the load via decided semiconductor switches, and thus each load phase preferably is connected with the lowermost voltage level via a decided switch configuration. In a preferred aspect of the invention, it thus is provided that for each phase branch for the innermost levels the multilevel pulse-controlled inverter includes semiconductor switches arranged in the form of a switch configuration, which are arranged such that they can be used exclusively for activating a phase branch.

In a further aspect of the invention it is provided that the multilevel pulse-controlled inverter includes semiconductor switches of a level higher than the innermost level, wherein the semiconductor switches of the higher level are arranged such that a plurality of phase branches can be used for activation. Preferably, it is provided that a multiple semiconductor switch is arranged such that it performs the activation of phase branches of different loads. It is conceivable, for instance, that the multiple semiconductor switches each are used for activating two phase branches.

The inventive principle of decided and multiple semiconductor switches can be extended to any number of loads, phases and levels and thus is not expressly restricted to for instance three or four phases and two levels.

In a further aspect of the invention it is provided that the higher level is the level following the innermost level. Thus, it is conceivable that the next higher voltage level(s) is/are connected with the next voltage level(s) via shared semiconductor switches.

In one example, the multilevel pulse-controlled inverter thus can be configured such that a plurality of voltage levels can be applied to the loads. There can exist a lowermost voltage level, and the multilevel pulse-controlled inverter can be configured such that the lowermost voltage level is applied to the decided semiconductor switches, whereas one or more higher voltage levels are applied to the multiple semiconductor switch(es).

It is conceivable that one or more voltage levels exist, which are applied to decided semiconductor switches, and one or more voltage levels which are applied to multiple semiconductor switches.

Furthermore, it can be provided that the control unit or control logic is configured such that the activation of the decided semiconductor switches is effected sequentially. It is likewise conceivable that the control unit or control logic is configured such that the activation of the decided semiconductor switches is effected simultaneously.

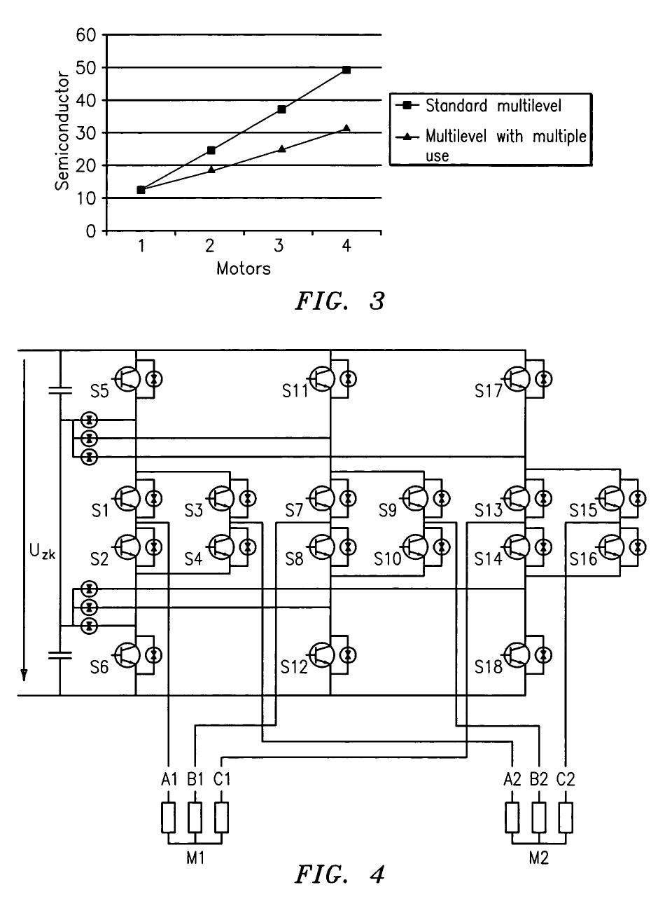

Due to the multilevel topology in accordance with the invention, the advantages of a multilevel arrangement can be utilized for a plurality of multiphase loads, such as three-phase a.c. motors, with a reduced number of semiconductor switches. FIG. 3 shows the reduction of the number of semiconductor switches in dependence on the number of motors for the case of a standard multilevel pulse-controlled inverter known from the prior art (upper line) and for the multilevel pulse-controlled inverter in accordance with the present invention (lower line).

As compared to two separately constructed multilevel inverters, the number of semiconductor switches thus can distinctly be reduced in accordance with the invention.

The present invention furthermore relates to a system with a device according to any of the preceding claims and with one or more multiphase electric loads connected with the device. The multiphase electric loads can be electric machines, in particular electric motors.

It is conceivable, for instance, that the electric motors are those for operating a landing flap drive and/or a landing gear drive of an aircraft.

This invention finally relates to an aircraft with one or more devices according to any of claims 1 to 11 and/or with one or more systems according to any of claims 12 to 14.

Further details and advantages will be explained in detail with reference to an embodiment illustrated in the drawing, in which:

FIG. 1: shows a standard inverter structure,

FIG. 2: shows a standard multilevel inverter structure,

FIG. 3: shows the comparison of a standard multilevel pulse-controlled inverter structure with a multilevel pulse-controlled inverter structure in accordance with the present invention,

FIG. 4: shows a multilevel pulse-controlled inverter structure in accordance with the present invention with three-phase loads, and

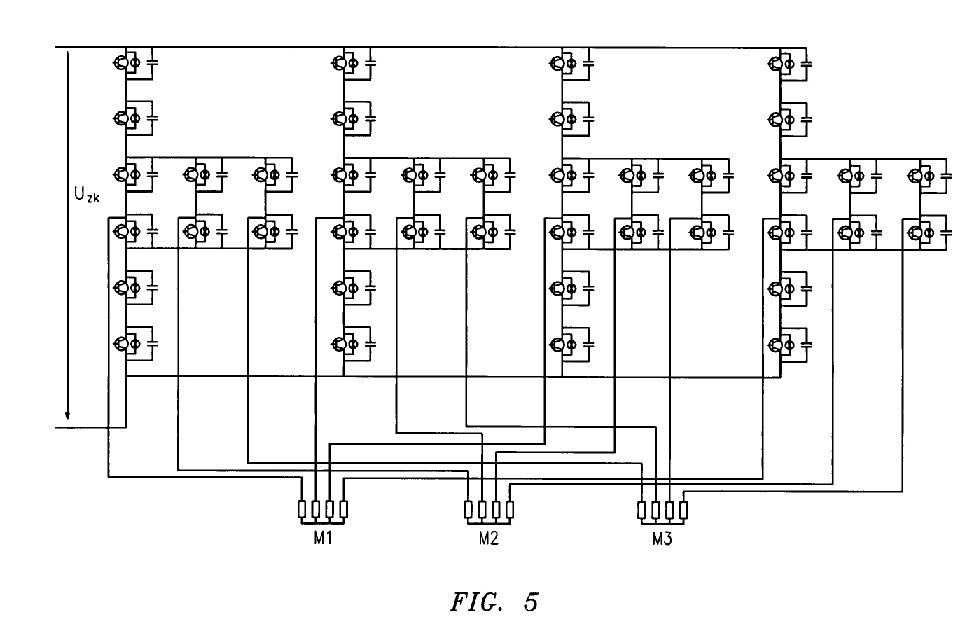

FIG. 5: shows a multilevel pulse-controlled inverter structure in accordance with the present invention with four-phase loads.

FIG. 4 shows an extended multilevel pulse-controlled inverter topology in accordance with the present invention.

The structure is illustrated with reference to a three-level diode-clamped three-phase pulse-controlled inverter in accordance with the invention for two three-phase loads M1 and M2.

As can be taken from FIG. 4, one switch configuration is used for each phase branch (A1, A2, B1, B2, C1, C2) for the innermost levels. For instance, for the phase branch A1 the switch configuration comprising the semiconductor switches S1 and S2 is used. This switch configuration and/or the semiconductor switches S1, S2 thereof is/are decided, as it is only used for activating the phase branch A1 of the load M1.

The same is true for the switch configuration with the switches S3, S4; S7, S8; S9, S10; S13, S14; S15, S16, which are each used for one of the phase branches A2; B1; B2; C1; C2 of the two illustrated loads M1 and M2.

As can furthermore be taken from FIG. 4, the switches of the next upper level, for instance the switches S5 and S6, are used for activating a plurality of phase branches. In the embodiment shown here, the switches S5 and S6 are used for activating the phase branches A1 and A2 together. Thus, these are multiple semiconductor switches in accordance with the present invention, which are used for activating a plurality of phase branches of the two illustrated loads.

Activating the phase branches can be effected simultaneously or also sequentially by a suitable activation method.

As already explained above, the principle of the invention as shown in FIG. 4 can be extended to any number of loads, phases and levels. The connection between the various voltage levels, such as diode-clamped, capacitor-clamped, cascades, etc., is irrelevant. All conceivable kinds of the various connections are covered by the present invention.

FIG. 5 shows an arrangement in accordance with the present invention, in which four-phase loads M1, M2 and M3 are supplied. There is illustrated a four-level, four-phase capacitor-clamped multilevel inverter for three four-phase loads M1, M2 and M3. In the embodiment shown in FIG. 5, three four-phase motors are activated. By way of example, the example of FIG. 5 shows how the principle underlying the present invention can be extended as desired.

As explained above, the advantages of a multilevel arrangement can be utilized for a plurality of loads, such as motors with a reduced number of semiconductor switches, due to the inventive topology of a multilevel pulse-controlled inverter.

1. A device for supplying a plurality of multiphase electric loads, wherein the device includes at least one multilevel pulse-controlled inverter, which comprises at least one decided and at least one multiple semiconductor switch.

2. The device according to claim 1, wherein the multiple semiconductor switch(es) is/are arranged on a higher level of the multilevel pulse-controlled inverter than the decided semiconductor switch(es).

3. The device according to claim 2, wherein the decided semiconductor switch(es) is/are arranged on the innermost level of the multilevel pulse-controlled inverter.

4. The device according to claim 1, wherein the multilevel pulse-controlled inverter includes semiconductor switches arranged in the form of a switch configuration, and the half-bridge is arranged such that it can exclusively be used for activating a phase branch of a load.

5. The device according to claim 4, wherein the half-bridge is arranged on the innermost level of the multilevel pulse-controlled inverter.

6. The device according to claim 4, wherein the switch configuration is made in the form of a half-bridge.

7. The device according to claim 1, wherein the multilevel pulse-controlled inverter includes semiconductor switches of a level higher than the innermost level, and the semiconductor switches of the higher level are arranged such that they can be used for activating a plurality of phase branches.

8. The device according to claim 7, wherein the higher level is the level following the innermost level.

9. The device according to claim 1, wherein a common control unit or control logic is provided, by which the control of the multiphase electric loads is effected.

10. The device according to claim 1, wherein a control unit or control logic is provided, which is configured such that activating the decided semiconductor switches is effected sequentially.

11. The device according to claim 1, wherein a control unit or control logic is provided, which is configured such that activating the decided semiconductor switches is effected simultaneously.

12. A system with a device according to claim 1 and with a plurality of multiphase electric loads connected with the device.

13. The system according to claim 12, wherein the multiphase electric loads are electric machines, in particular electric motors.

14. The system according to claim 13, wherein the electric motors are electric motors for driving the landing flaps of an aircraft and/or for driving the landing gear of an aircraft.

15. An aircraft with a device according to claim 1.

16. An aircraft with a system according to claim 12.

17. The device according to claim 2, wherein the multilevel pulse-controlled inverter includes semiconductor switches arranged in the form of a switch configuration, and the half-bridge is arranged such that it can exclusively be used for activating a phase branch of a load.

18. The device according to claim 3, wherein the multilevel pulse-controlled inverter includes semiconductor switches arranged in the form of a switch configuration, and the half-bridge is arranged such that it can exclusively be used for activating a phase branch of a load.

19. The device according to claim 18, wherein the half-bridge is arranged on the innermost level of the multilevel pulse-controlled inverter.

20. The device according to claim 17, wherein the half-bridge is arranged on the innermost level of the multilevel pulse-controlled inverter.
